(19) United States
(12) Patent Application Publication
(10) Pub. No.: US 2010/0301110 A1
(43) Pub. Date: Dec. 2, 2010

(54) BAR CODE BAG

(76) Inventor: Vittoria Carnevale, San Lucido (IT)

Correspondence Address: YOUNG & THOMPSON, 209 Madison Street, Suite 500, Alexandria, VA, 22314, US

(21) Appl. No.: 12/524,983

(22) PCT Filed: Jan. 30, 2008
(86) PCT No.: PCT/IT08/00058

§ 371 Date: Jul. 29, 2009

(30) Foreign Application Priority Data
Feb. 1, 2007 (IT) RM2007U000033

(51) Int. Cl. G06Q 30/00; B65D 33/06; B65D 30/02

(52) U.S. Cl. 235/375; 383/6; 383/1

(57) ABSTRACT

In order to identify each single client that regularly buys products in the same shop or group of shops, an innovative, specific, reusable shopping bag is proposed. The characterising feature of this bag resides in the client's identification via a bar code that may be permanently or removably applied on the bag, preferably on the outer side thereof. This bar code may be read by an optical reader in order to sum the number of purchase operations performed by the client during a certain time period, to thereby determine her/his faithfulness. The bag may be produced in various shapes and materials, in particular it could be made of natural, synthetic, or mixed fabrics.

### TECHNICAL FIELD

The present invention concerns a new kind of bag to be used for shopping purposes in supermarkets, or for purchasing products in wholesale or retail shops, or in chemist's shops, or in any kind of commercial activity accessible to the public.

### BACKGROUND ART

Presently, on the market there is a wide and diversified offer of bags, both with regard to their constituent materials and to their shapes and sizes. Their use is multifarious, including the classical shopping bags and bags used by various kinds of commercial activities.

The bag handles are available in different shapes, materials, thicknesses/resistances (elongated, short, produced by die cutting, vest-like, bean-shaped, rigid, with a twine, made of plastics, cloth, paper, etc.), like the bags themselves, which may have a reinforced bottom part, a welded bottom, a bellows-like lateral part, etc.

The materials used for producing the bags could be obtained from chemical synthesis or could be biodegradable materials. There is also a wide offer of paper, cardboard, or thin-cardboard bags, also obtainable from recycling processes. Reusable bags may be made of natural materials, for instance cotton, jute, nonwoven fabric, or of synthetic fabrics, or of mixed materials. Also available are reusable net-like bags, made of synthetic or natural materials.

Generally, bags have variable sizes and resistances, suited to the size and weight of the products sold by the respective commercial activity. Lateral bellows are an example of how to increase the bag size, when the bag is actually used by the user (final client), while insuring its compact (flat) shape during transportation before its utilisation (space optimisation by piling the bags on each other).

Moreover, nearly all bags present on the market have some characteristic feature, not only with regard to their material, shape, and size, but also under the aspect of their colours, their “raw” appearance as for instance in case of some reusable bags, or by virtue of the presence of advertising and/or information notices (logo, seat, etc.) or of educational messages (e.g. messages concerning an ecologically correct behaviour), or by virtue of the presence of advertising texts used to describe the features of the bag (e.g. relating to the materials used to produce the bag).

However, up to now nobody has ever thought of identifying bags of these kinds in a univocal manner. Actually, till now, bags handed over to clients by traders, wholesale dealers or retailers, bear features related to the kind of commercial activity (shop), as already emphasised, or to the physical properties of the bag itself, which could be provided with a particular design/decorations/ornaments for the purpose of its commercial identification but not for its univocal identification. On the other hand, a system for univocally identifying a bag would be extremely useful, for instance, for “monitoring the number of purchases” ascribable to each individual client in the same shop, or in the same group of shops belonging to the same corporation.

A further application concerns a competition (contest) in which points are collected/scored for the award of a prize. That is, a client using many times and continuously the same univocally identifiable bags, to purchase products in a specific group of shops, or in the same supermarket, chemist's shop, etc., will increase (increment) the value of a counter when he/she pays at the desk, and in this manner, when reaching a certain threshold (number) of passages at the desk—possibly summed with respect to all the shops of the same corporation/group—he/she will be awarded, for instance, the prizes of the competition, or discount tickets for future purchases, or the like. This allows to “prevent” a client from using the bag of the present invention only once and from throwing it away. The fact that a client will seek to reuse a bag several times, thereby allows, at the same time, to reduce the amount of waste produced and consequently to limit environmental pollution.

To this end it is indispensable to dispose of a system capable of univocally identifying an individual bag, or group of bags, to be delivered to an individual client or to a certain category of clients.

The present invention aims at solving this problem without substantially increasing the costs of the usual production processes of a bag, and without modifying in practice the overall aesthetic appearance of the bag, that is, without impairing its aesthetic value.

### DISCLOSURE OF INVENTION

In substance, the present invention solves the abovementioned technical problem by providing a new, reusable bag, which is characterised by having at least one bar code. Although bar codes are largely used nowadays to classify different products to be sold in shops, and for incrementing the value of the final bill for the client, by the respective price of each individual sold product (by using an optical reader), when this client pays at the desk, bar codes have never been utilized on bags used by a purchaser, for the purpose of monitoring the fidelity degree of a purchaser and for tempting him/her to reuse the bag in order to contribute to an effective reduction of the amount of rubbish, by a new use of the same bag.

A bar code is small-sized, and for this reason it has the advantage of not modifying the overall appearance of the bag; the latter, consequently, would not be subjected to substantial modifications of its “look” as originally established/designed by the manufacturer. Moreover, a bar code, unlike a simple client identification number, is more difficult to falsify and can only be read by a special optical reader available to the salesman or the person who runs the commercial activity.

The way the bare code is applied/attached/printed may vary according to the material of the bag. If this bag forms a net, it is possible to provide the bar code on a tag (sticker or label), to be attached to the net in an appropriate manner. The tag with the bar code could also be attached in a removable manner to the bag, so that the same bag could be reused by other clients as well, at the end of a certain “monitoring” activity, advertising campaign, collection of points, various offers, etc., which could last for a period of e.g. one year. At the end of the monitoring period, the administrator of the shop—or group of shops—could for instance deliver a discount ticket to the most “faithful” clients, or even a prize belonging to the same typology of products preferred by those clients, or grant access to any other form of promotional sales. According to a preferred embodiment, which e.g. provides for the award of prizes based on the number of passages at the desk (collected points), in order to prevent abuses by clients—who could pass several times within a period of only a few hours (time period Δt)—, the information recorded in the system memory does not only relate to the counter of the number of passages, but also includes the date and hour (hh.mm.ss) of the passage/payment at the desk. Therefore, at the time the client pays at the desk, it is checked, in real-time, if the previous passing/payment occurred more than Δt hours before; in the affirmative, the counter increments its value by one, whereas in the opposite case it does not modify the presently memorised value.

Alternatively, assuming that it is possible to verify the good faith of a client, the bag of the present invention could be used in a way to allow a client to perform more passages even within a reduced period of time (Δt). This should be allowed to induce this client, who may have forgotten to purchase a certain product, to enter the shop again in order to buy that product.

If the bag is made of thin cardboard or polymeric plastic material, or of any type of polymer present in nature, or of a biodegradable or recyclable material, the bar code can be directly applied to the thin cardboard, plastic material or natural material, by means of a suitable printing process, like lithographic printing or respectively “dip print”, during the same process in which other words or images are also printed, or alternatively, in a separate printing process.

The choice will obviously depend on the possibility of reducing production costs.

### DESCRIPTION OF A SPECIFIC EMBODIMENT OF THE INVENTION

As already mentioned, the reusable bag of the present invention has at least one bar code. This bar code, provided it is desired to not modify at all the aesthetic appearance of the reusable bag, will be applied on the lower part (for instance on the reinforced bottom of the bag), so that it will not be noticed by an observer during transportation of the products bought by the client. The bar code can be printed on a tag or sticker, which in turn could be applied on the bag in a removable way (e.g. inserted inside a small pocket of the bag) or not. If the bag is made of plastics, the bar code will preferably be directly printed on the bag itself. The bag could be made of natural fibre, nonwoven fabric, synthetic fabric, mixed fabric, with a single colour, or with many colours, or with a customized print, even with a “raw” effect, and the handle may have one or more of the following features:
an elongated or short form, obtained by die cutting, a vest-like shape, a bean-like shape, either rigid or soft;
a material of natural fibre, a material for producing cords/strings, plastics, cloth, paper, nonwoven fabric, synthetic fibres and recycled materials.

The shape of the bag may be flat or is expandable in depth, and it could be either rigid or have lateral bellows.

The material of the handle may be of a different kind than that of the bag. Since the bag is reusable, wear-resistant materials are preferred, and also materials resistant to atmospheric agents and to loads according to the type of products that can be bought in a particular shop, supermarket or a common commercial activity. For illustrative and non-limitative purposes, the bag dimensions could be comprised in the following values:
height: from 10 centimetres to 70 centimetres;
width: from 10 centimetres to 90 centimetres;
depth: from flat bottom to 30 centimetres.

### Example

In a very particular embodiment, though not intended to be limitative or binding, the invention consists in a reusable bag with a bar code, whose utilisation consists in promoting participation to advertising campaigns, competitions including the award of prizes, collection of points (scores), wherein the bag has the following features:
material: natural fibre;
handles: short or vest-like, made of natural fibre;
shape: with a lower part expandable in depth or has lateral bellows, wherein, in both cases the total depth is 20 centimetres;
dimensions: height 65 centimetres-width 35 centimetres;
colour: natural colour, customizable (with messages, logos, information).

1. A reusable bag, including a handle and a body, characterised in that it is provided with at least one bar code, preferably applied on the outer side of the bag, to allow identification of a single client who buys products in a shop, or in a certain group of shops, the bar code being suited to be read by an optical reader when the client pays at the desk, to thereby increase the value of an electronic counter indicating and storing in an electronic memory the number of passages of the client at anyone of the desks of the shop or supermarket, or the group of shops, said passages occurring in a predetermined time span that can be set at will by the administrator of the commercial activity, shop, or group of shops.

2. A bag according to claim 1, characterised in that said bar code is directly printed on the material of the bag.

3. A bag according to claim 1, characterised in that said bar code is printed on a tag o label, which in turn is applied on the bag.

4. A bag according to claim 3, characterised in that the tag is applied in a removable way on the bag, so that the same bag can be reused for other clients.

5. A bag according to claim 2, characterised in that the bar code is printed in a single printing process, simultaneously with the other figures or words designed to appear on the bag.

6. A bag according to claim 2, characterised in that the bar code is printed in a separate printing process, distinct from the printing process involving other figures or words designed to appear on the bag.

7. A bag according to claim 1, characterised in that the handle is made of a material different from the body of the bag.

8. A bag according to claim 1, wherein the handle and the body are made of the same material.

9. A bag according to claim 1, characterised in that it is at least partially made of a cloth forming a net.

10. A bag according to claim 1, characterised in that it is at least partially made of recycled material.

11. A bag according to claim 1, characterised in that it comprises, at least partially, a biodegradable material.

12. A bag according to claim 1, characterised in that it comprises, at least partially, a synthetic material.

13. A bag according to claim 1, characterised by a bottom that can be expanded in depth.

14. A bag according to claim 1, characterised by a bellows-like bottom.

15. A bag according to claim 1, characterised by a flat bottom.

16. A bag according to claim 13, characterised by a bottom which is reinforced or welded.

17. A bag according to claim 1, characterised in that it comprises at least in part natural fabric and/or nonwoven fabric and/or synthetic fabric and/or mixed fabric.

18. A bag according to claim 1, characterised in that it comprises decorative elements, with fancy colours or a single colour, logos, figures, written text, etc.

19. Method of identifying an individual client having a bag provided with at least one bar code, which comprises reading said bar code with an optical reader when said client pays at the desk of a shop, a supermarket, a chemist's shop, or the like, which may belong to the same group of commercial activities, either of the same type or not.

20. Method of identifying an individual client according to claim 19, wherein each reading increases the value of an electronic counter that sums up the number of times a specific client pays/passes at one of the desks of a particular shop or group of shops, said number of passages being stored in an electronic memory during a predetermined “monitoring” time span that may be set and modified at will by the administrator of the shop or shops; wherein, the total, provisional number of passages of the client can be displayed, during each passage, on a display at the respective desk, or can be printed on a delivery-note or on a corresponding fiscal document, or on an apposite note delivered to the client, to thereby testify, at the end of said “monitoring” time span, by means of a final total number, the fidelity degree of the client in relation to a specific shop or a specific group of shops.

21. The method according claim 20, wherein, besides incrementing the value of the counter during each client's passage, the system also memorises the time (date and hour: hh.mm.ss) of the passing, and said counter being incremented only on condition that a predefined time (Δt) has passed from the previous passing.

22. The method according to claim 20, wherein, only the client's bag passing is detected and stored in the counter, irrespective of the time passed after the last memorization.
